(19) United States
(12) Patent Application Publication
(10) Pub. No.: US 2004/0179121 A1
(43) Pub. Date: Sep. 16, 2004

(54) System and method for displaying captured images according to imaging device position

(76) Inventor: D. Amnon Silverstein, Mountain View, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/387,960

(22) Filed: Mar. 12, 2003

(51) Int. Cl. H04N 5/222

(52) U.S. Cl. 348/333.01

(57) ABSTRACT

A system and method for displaying images of a scene captured by an imaging device selectively displays the images at different locations on a display according to the position the device. The selective displaying of the images allows a user to readily determine the position of the imaging device.

### FIELD OF THE INVENTION

The invention relates generally to imaging systems, and more particularly to a remote-controllable imaging system.

### BACKGROUND OF THE INVENTION

Imaging systems that can be remotely controlled are becoming more widely used to monitor activities at remote sites. Unlike a simple surveillance video camera system, a remote-controllable imaging system allows a user to control one or more video cameras to view different areas of a remote site. A remote-controllable imaging system includes at least one video camera, a camera server, and a remote control device with a monitor to display the video images captured by the video camera. The remote control device may be a personal computer that is running an application that can interface with the video camera via the camera server to receive video images from the video camera and to transmit control signals to change the position the video camera. The position of a video camera is defined by the panning and tilting angles of the video camera. Thus, the camera position corresponds to the viewing direction of the video camera. The video camera is connected to the camera server, which may also be connected to the remote control device by cable or via a communication network, such as the Internet or an intranet.

In a conventional remote-controllable imaging system, the video camera is controlled by the user using the video images captured by the video camera as visual references for the camera position. Thus, the only information to the user with respect to the current position of the video camera is the captured video images that are displayed on the monitor of the remote control device. As an example, in FIGS. 1 and 2, video images 102 and 202 captured by a video camera at two different camera positions are displayed on a monitor 104. The video image 102 is a captured image of a portion 302 of a viewable scene 304, shown in FIG. 3, while the video image 202 is a captured image of a region 306 of the viewable scene. The viewable scene is the area of a site that can be viewed by the video camera by changing the camera position, i.e., the panning and tilting angles of the camera. Thus, the displayed video image 102 corresponds to the camera position when the video camera is positioned to view the region 302 of the viewable scene. Similarly, the displayed video image 202 corresponds to the camera position when the video camera is positioned to view the region 306 of the viewable scene. Without prior knowledge of the viewable scene, a user cannot readily determine the position of the video camera by simply viewing the video image 102 or 202 displayed on the monitor 104.

A concern with the conventional remote-controllable imaging systems that use the captured video images as visual references is that changing the position of a video camera to point to a desired region of a viewable scene can be a challenging task, since the user will typically not know the location of the desired region with respect to the current displayed video images. As an example, if the current video image of a viewable scene displayed on a monitor is the video image 102 of FIG. 1 and the user wants to move the video camera to a camera position that corresponds to the video image 202 of FIG. 2, then the user need to search the viewable scene by panning and tilting the camera, unless the user has prior knowledge of the viewable scene. Another concern is that the user can easily become disoriented using the displayed video images when moving the video camera. As an example, if the video camera is pointing at the ceiling, then the user may erroneously believe that the camera is pointing at a wall. Still another concern is that the captured video images do not provide direct information regarding the current pointing direction of the video camera. Most video cameras have limited panning and tilting ranges. Unless the user can determine the current position of the video camera from the displayed video images, the user will not know when the video camera has reached the maximum panning and/or tilting angle, unless the user has prior knowledge of the scene.

In view of the above-described concerns, what is needed is a system and method for displaying images captured by an imaging device, e.g., a video camera, which provides information about the position of the imaging device.

### SUMMARY OF THE INVENTION

A system and method for displaying images of a scene captured by an imaging device selectively displays the images at different locations on a display according to the position the device. The selective displaying of the images allows a user to readily determine the position of the imaging device. As a result, the user can more easily change the position of the imaging device to capture desired images of the scene. In an exemplary embodiment, a graphic user interface (GUI) is used to view the captured images, as well as control the position of the imaging device in an intuitive manner.

A system in accordance with an embodiment of the invention includes an interface to receive an input image by an imaging device that corresponds to a region of a scene viewable by the imaging device, a display that can display the input image on a portion of the display and a display controller configured to position the input image at a location on the display that corresponds to a position of the input imaging device with respect to the scene when the input image was captured.

A method in accordance with an embodiment of the invention includes steps of receiving an input image captured by an imaging device that corresponds to a region of a scene viewable by the imaging device and displaying the input image on a portion of a display. The step of displaying the input image includes positioning the input image at a location on the display that corresponds to a position of the imaging device with respect to the scene when the input image was captured. The method may be embodied as a computer program in a programmable storage device.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 shows a video image of a particular region of a viewable scene, which is displayed on a monitor, in accordance with the prior art.

FIG. 2 shows a video image of a different region of the viewable scene, which is displayed on the monitor, in accordance with the prior art.

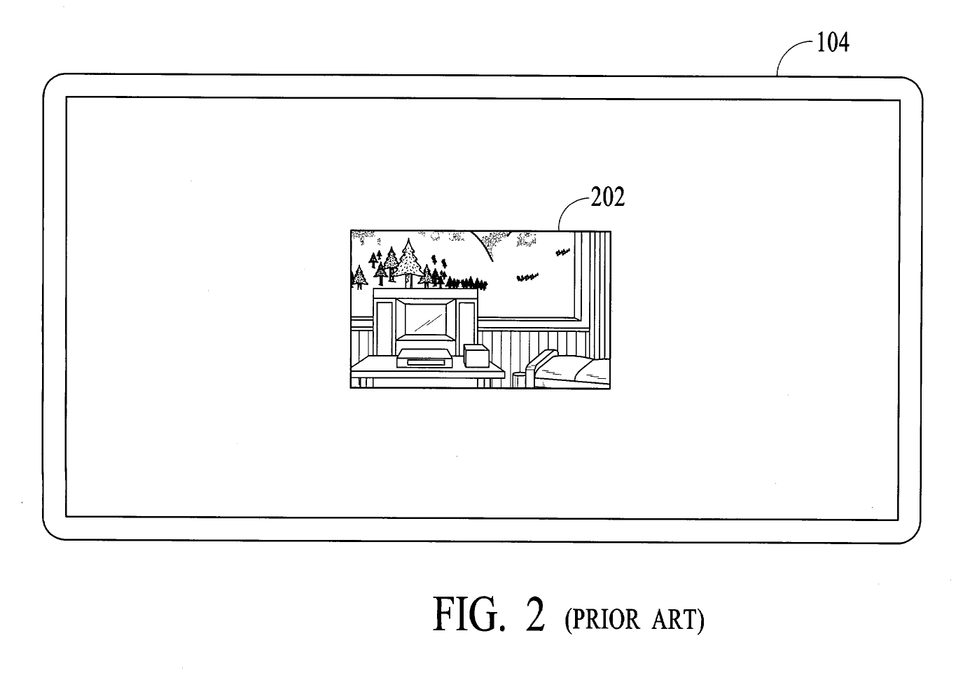

FIG. 3 shows the viewable scene, including the regions that correspond to the displayed video images of FIGS. 1 and 2.

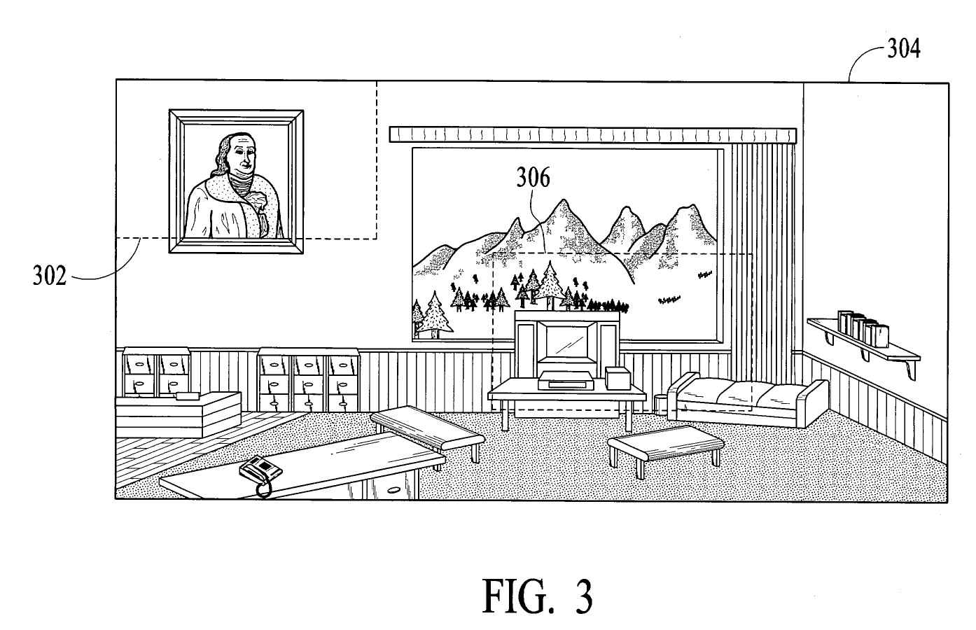

FIG. 4A shows a remote-controllable imaging system in accordance with an exemplary embodiment of the invention.

FIG. 4B shows a remote-controllable imaging system in accordance with another embodiment of the invention.

FIG. 5 illustrates a viewable scene, including a region of the viewable scene that is targeted by an imaging device of the remote-controllable imaging system of FIG. 4.

FIG. 6 shows an image of the targeted region of the viewable scene of FIG. 5, which is displayed in a scene frame on a monitor of the remote-controllable imaging system according to the position of the imaging device.

FIG. 7 shows an image of a different region of the viewable scene of FIG. 5, which is displayed on the scene frame on the monitor of the remote-controllable imaging system according to the position of the imaging device.

FIG. 8 illustrates the displaying of images captured by the imaging device as the imaging device is moved to a new position.

FIG. 9 shows a viewing frame displayed on the monitor along with the scene frame in accordance with an embodiment of the invention.

FIG. 10A is a process flow diagram of an overall operation of the remote-controllable imaging system in accordance with one embodiment of the present invention.

FIG. 10B is a process flow diagram of an overall operation of the remote-controllable imaging system in accordance with another embodiment of the present invention.

### DETAILED DESCRIPTION

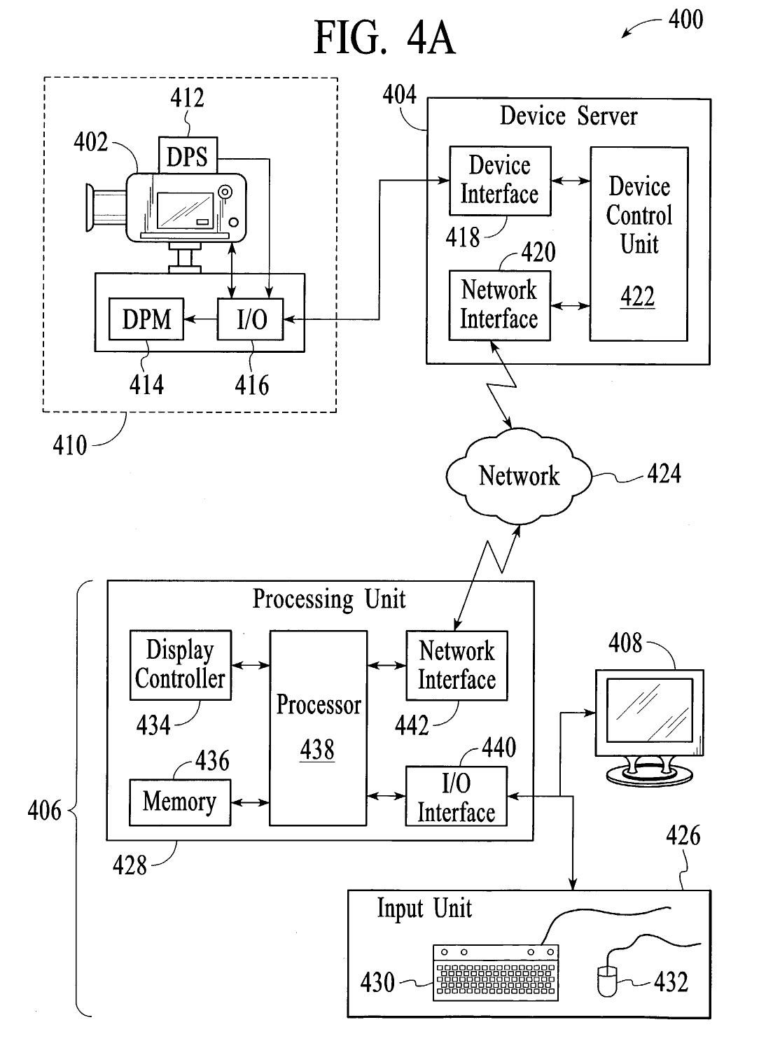

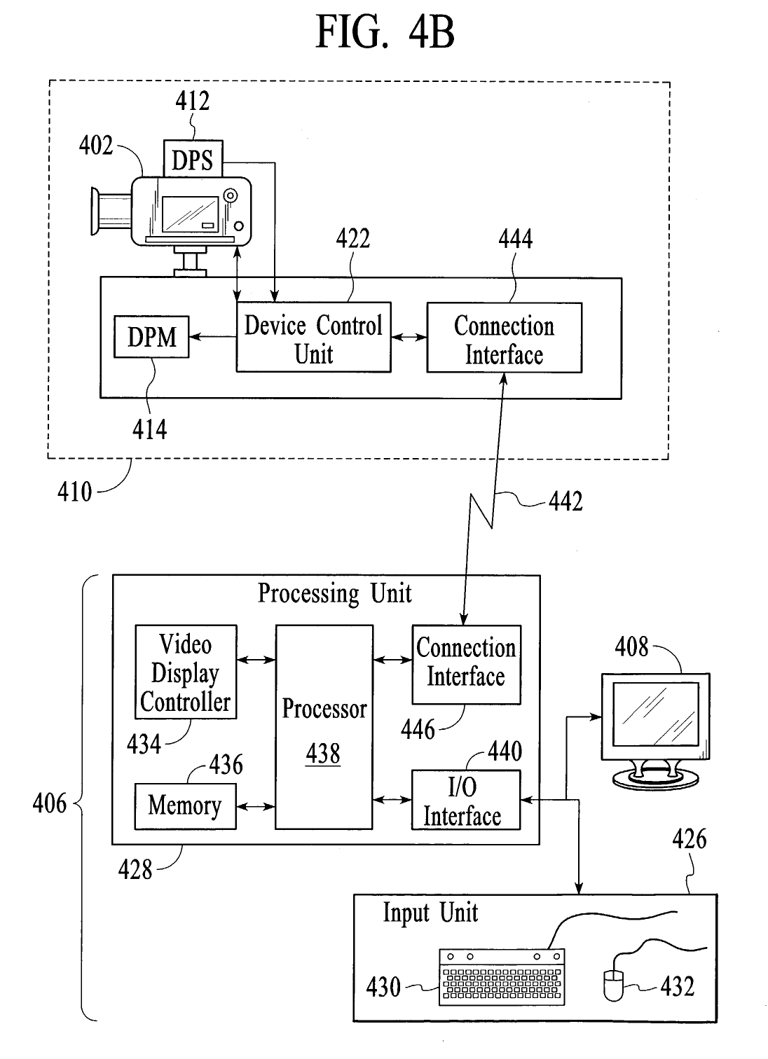

With reference to FIG. 4, a remote-controllable imaging system 400 in accordance with an exemplary embodiment of the invention is shown. The remote-controllable imaging system includes an imaging device 402, a device server 404, and a control device 406 with a monitor 408. Similar to conventional remote-controllable imaging systems, the remote-controllable imaging system 400 allows a user at the control device to view images captured by the imaging device on the monitor and to control the position of the imaging device to change the pointing direction of the imaging device. However, unlike conventional remote-controllable imaging systems, the captured images are displayed at different locations on the monitor, depending on the pointing direction of the imaging device when the images were captured. Thus, the location of the captured images displayed on the monitor indicates the current pointing direction of the imaging device, which allows the user to more easily control the imaging device.

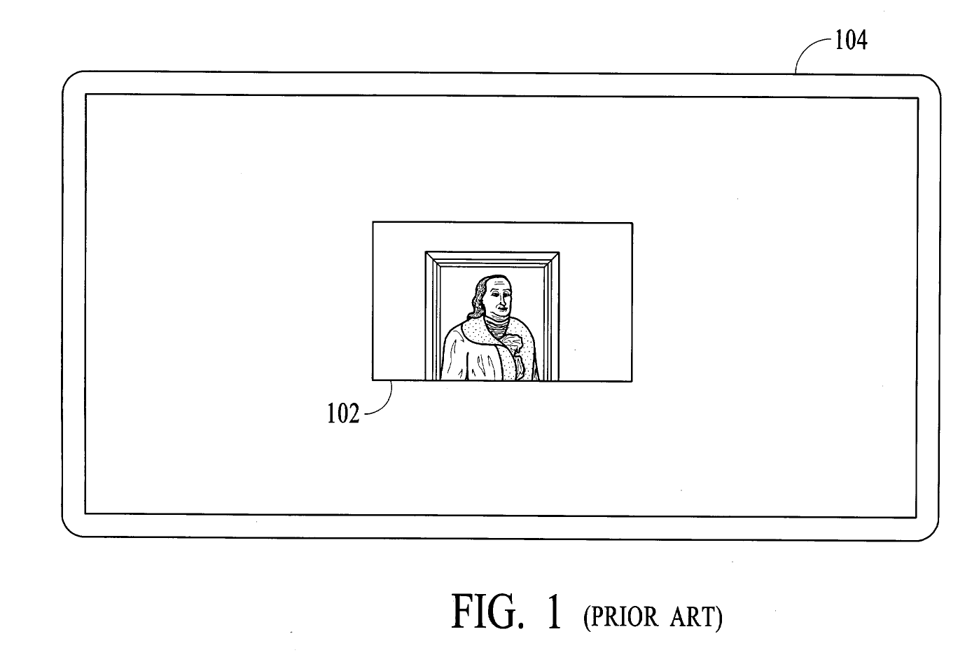

The imaging device 402 of the remote-controllable imaging system 400 operates to capture images of targeted regions of a viewable scene in an analog or digital format. The imaging device may be a video camera, a still camera, or any imaging device that can capture spatial images, which may be captured using sonar, x-rays, radar, lidar, visible light, infrared light, ultraviolet light, magnetic resonance or any other known imaging means. In an exemplary embodiment, the imaging device is configured to capture images in a digital format. In this embodiment, the imaging device may utilize a charge-coupled device (CCD) or complementary metal-oxide semiconductor (CMOS) sensor to capture the images. The imaging device is part of an imaging assembly 410 that includes a device position sensor (DPS) 412, a device positioning mechanism (DPM) 414, and an input/output (I/O) interface 116, as shown in FIG. 1.

The device position sensor 412 of the imaging assembly 410 operates to determine the current position of the imaging device 402. A position of the imaging device may be defined by the panning and tilting angles of the imaging device. The panning angle relates to the horizontal rotation of the imaging device, while the tilting angle relates to the vertical rotation of the imaging device. Alternatively, a position of the imaging device may be defined by horizontal and vertical shifts of the imaging device. Consequently, the device position sensor is configured to determine the current panning and tilting angles of the imaging device or the current horizontal and vertical shifted positions of the imaging device. As an example, the device position sensor may be a potentiometer. The device position sensor may be further configured to determine the rotational angle of the imaging device. The rotational angle relates to a rotational movement of the image about an axis defined by the pointing direction of the imaging device. If rotational angle is also determined by the device position sensor, the position of the imaging device is defined by the panning, tilting and rotational angles, or is defined by the horizontal and vertical shifted positions and the rotational angle. Thus, the device position sensor is configured to determine at least one angle of the imaging device, which may be any one of panning, tilting and rotational angles.

The device positioning mechanism 414 of the imaging assembly 410 operates to move the imaging device 402 in response to input control signals, which are generated at the control device 406 by a user and transmitted to the device positioning mechanism through the device server 404. The device positioning mechanism is configured to move the imaging device in the horizontal, vertical and/or rotational directions. The device positioning mechanism may utilize servo or step motors to move the imaging device.

The I/O interface 416 of the imaging assembly 410 operates to interface the imaging assembly with the device server 404. Thus, the I/O interface allows the imaging assembly to receive incoming signals from the device server and to transmit outgoing signals to the device server. The incoming signals include control signals to control the imaging device 402. The control signals may be any type of signal that can be used to control the imaging assembly, such as electrical, optical, radio, acoustic or other known signals. The outgoing signals include image data of the images captured by the imaging device and device position data from the device position sensor 412. The incoming and outgoing signals may also include other types of signals.

The device server 404 of the remote-controllable imaging system 400 includes a device interface 418, a network interface 420 and a device control unit 422. Similar to the I/O interface 416 of the imaging assembly 410, the device interface allows the device server to interface with the imaging assembly. The device interface is configured to transmit the control signals that are used to control the imaging assembly. In addition, the device interface is configured to receive the image data of the captured images and the device position data from the imaging assembly. Although the I/O interface 416 and the device interface 418 are illustrated as being connected directly to each other, these interfaces may be indirectly connected through an intermediate device or network. In addition, the connection between the interfaces can be a cable connection or a wireless connection.

The network interface 420 of the device server 404 operates to provide a communication link between the device server 404 and the control device 406 via a network 424. The network may be any type of communication network, such as the Internet, LAN, WAN, etc. The network interface may be a dial-up modem, a DSL modem, a cable modem, an ethernet card, a wireless network card, or any appropriate network interface device.

The device control unit 422 of the device server 404 operates to transmit control signals to the device positioning mechanism 414 of the imaging assembly 410 to move the imaging device in response to control signals from the control device 406. Furthermore, the device control unit may also transmit control signals to the imaging device 402 to control various functions of the imaging device, such as zoom, focus, brightness, exposure, etc.

Although the imaging assembly 410 and the device server 404 are described and illustrated as separate devices, the imaging assembly and the device server may be integrated into a single device. Thus, in this integrated configuration, the I/O interface 416 of the imaging assembly and the device interface 420 of the device server are not needed.

The control device 406 of the imaging system 400 includes an input unit 426, a processing unit 428, and the monitor 408. The control device allows a user to view images captured by the imaging device 402 on the monitor. In addition, the control device allows the user to control the imaging device, including changing the position of the imaging device. Similar to the imaging assembly 410 and the device server 404, two or more of the components 408, 426 and 428 of the control device may be integrated. As an example, all three components may be integrated into a single device in the form of a personal digital assistant (PDA). Thus, in this example, the input unit, the processing unit and the monitor may be integrated components of the PDA.

The input unit 426 of the control device 406 allows a user to input commands into the imaging system 400. In addition, the input unit allows the user to input parameters that are used by the system. In the exemplary embodiment, the input unit includes a computer keyboard 430 and a computer mouse 432. However, the input unit may include any type of electronic input devices. In an embodiment in which the input unit and the processing unit 428 are integrated, the input unit may simply be buttons, dials, levers and/or switches on the processing unit.

The monitor 408 of the control device 406 allows a user to view images captured by the imaging device 402. The monitor may be any display device, such as a CRT monitor or a flat panel display. In an embodiment in which the monitor and the processing unit 428 are integrated, the monitor may be a liquid crystal display, which is attached to the processing unit.

The processing unit 428 of the control device 406 operates to receive the image data of the images captured by the imaging device 402 and dynamically display the images on the monitor 408 so that a user can readily determine the current position of the imaging device. The processing unit also transmits user commands to the imaging assembly 410 via the device server 404 to control the imaging device, including the position of the imaging device. The processing unit may be configured to allow a user to store selected images, as movie files or still image files. As shown in FIG. 4, the processing unit includes a display controller 434, memory 436, a processor 438, an I/O interface 440 and a network interface 442. The memory, the processor, the I/O interface and the network interface are components commonly found in a personal computer. Thus, these components are briefly described herein. The memory 436 is a storage medium that can be used to store images captured by the imaging device. The memory may also store various parameters that are used by the system, as well as other information. The memory may be a hard disk drive, a memory card, or other common forms of storage media. The processor 438 is configured to execute signal processing operations in conjunction with the display controller 434, as described below. The processor can be any type of digital signal processor. The I/O interface 440 allows the processing unit to be interfaced with the input unit 426 and the monitor 408. The network interface 442 provides an interface between the processing unit and the network 424.

In another embodiment, the remote-controllable imaging system 400 may be configured such that the processing unit 406 is directly connected to the imaging assembly 410 via a wired or wireless connection 442, as illustrated in FIG. 4B. In this embodiment, the device server 404 is integrated into the imaging assembly such that the device control unit 422 is included in the imaging assembly. In addition, the imaging assembly and the processing unit include connection interfaces 444 and 446 to directly transmit signals between the imaging assembly and the processing unit through the wired or wireless connection. Although not illustrated, in another embodiment, the remote-controllable imaging system 400 may be configured such that the processing unit 406 is directly connected to the device server 404 via a wired or wireless connection, such as the connection 442. In this embodiment, the device server includes the connection interface 444 so that signals can be directly transmitted between the device server and the processing unit through the wired or wireless connection.

The display controller 434 of the processing unit 428, in conjunction with the processor 438, operates to dynamically display images captured by the imaging device 402 at different locations on the monitor 408, depending on the position of the imaging device. Thus, the location on the monitor at which the captured images are displayed corresponds to the current position of the imaging device. In the exemplary embodiment, the display controller is implemented as software. However, the display controller may be implemented in any combination of hardware, firmware and/or software.

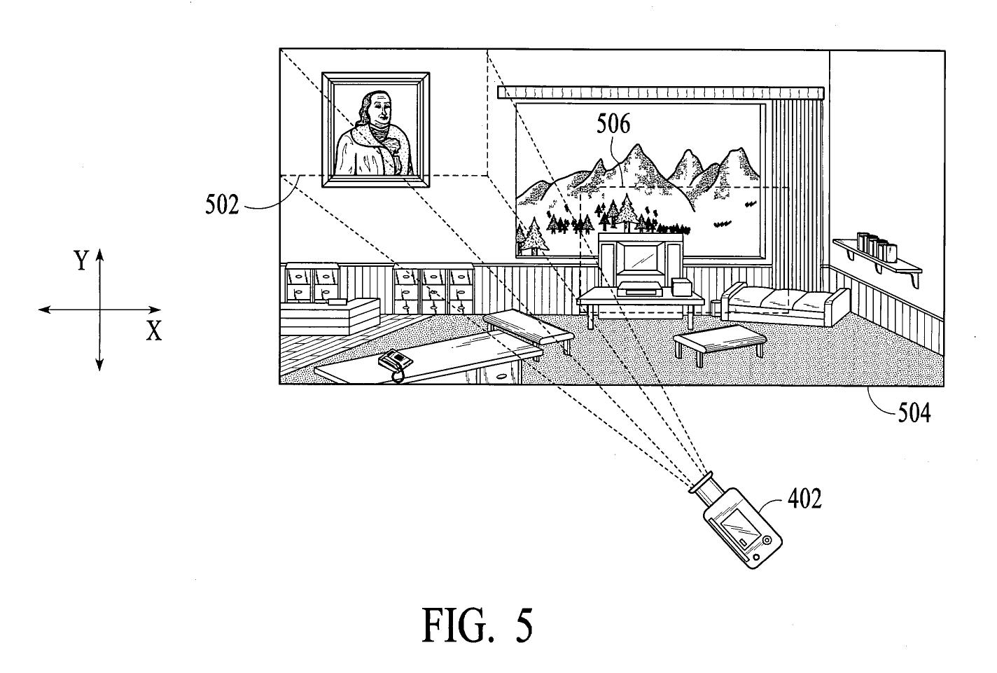

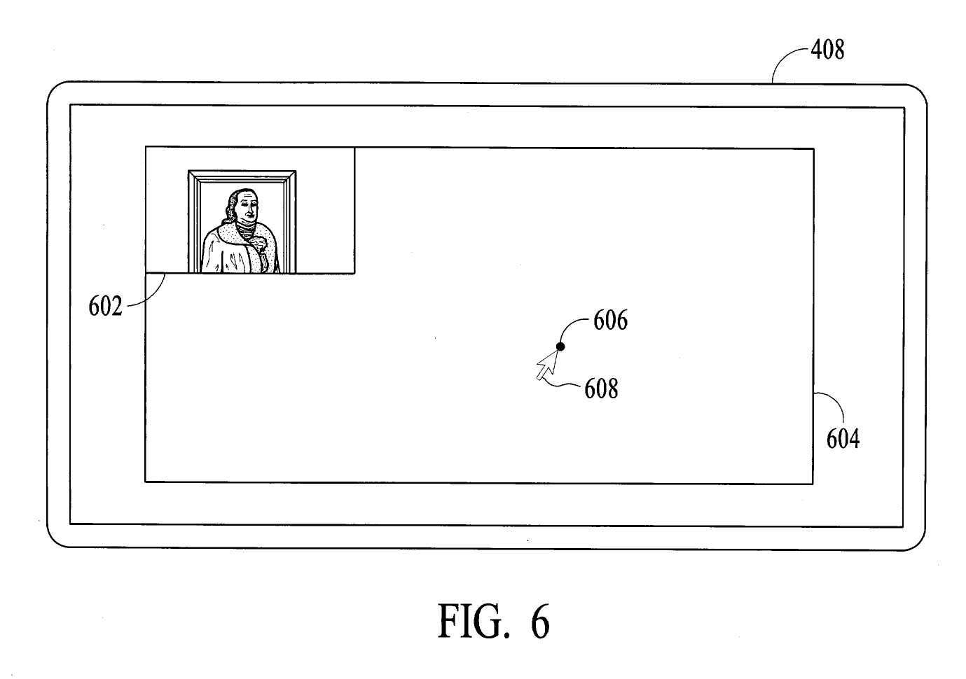

The core function of the display controller 434 is described using an example. In FIG. 5, the imaging device 402 is positioned to point to a region 502 of a viewable scene 504. The viewable scene is the area of a remote site that can be viewed by the imaging device by changing the position of the imaging device, e.g., the panning, tilting and/or rotational angles of the imaging device. A change in the panning angle of the imaging device moves the region of the viewable scene targeted by the imaging device along the X axis, while a change in the tilting angle moves the targeted region along the Y axis. A change in the rotational angle rotates the targeted region about its center. The region 502 of the viewable scene corresponds to a particular position of the imaging device when the imaging device is moved to the position where the tilting and panning angles are at their maximum positive values, in which the angles are defined from the center of the viewable scene. As shown in FIG. 6, the images of the region 502 captured by the imaging device at the current position are displayed on the monitor 408 in an image window 602. The image window is a portion of a scene frame 604 being displayed on the monitor. The scene frame represents the viewable scene 504. Thus, the location of the image window in the scene frame corresponds to the location of the region in the viewable scene being captured by the imaging device, which is dependent on the current imaging device position. Consequently, there is a correlation between the imaging device position and the location of the displayed images on the scene window. Therefore, a user can readily determine the current position of the imaging device by the location of the captured images displayed on the monitor.

The display controller 434 is able to determine the current position of the imaging device 402 in one of several alternative methods. In the exemplary embodiment, the display controller determines the current position of the imaging device by receiving positional information from the device position sensor 412 of the imaging assembly 410. As an example, if the device position sensor is a potentiometer, the positional information may be in the form of a voltage signal caused by a change in resistance of the potentiometer, which corresponds to the angular coordinates of the current position of the imaging device. Since the angular coordinates define the panning and tilting angles of the imaging device, the display controller can determine the current position of the imaging device by the signal from the device position sensor. In an alternative embodiment, the display controller determines the current imaging device position by interpreting a log of control inputs that were used to move the imaging device to the current position. As an example, if the imaging device was earlier commanded to pan twice to the right by ten degrees from a default position, e.g. the origin defined by the panning and tilting angles, then the display controller can determined that the current position of the imaging device is twenty degrees to the right by recalling the control inputs of the commands that were used to twice pan the imaging device to the right by ten degrees. In another alternative embodiment, the display controller determines the current imaging device position by analyzing the captured images. As an example, a captured image of a viewable scene may be compared to reference images of the viewable scene, in which the corresponding imaging device position for each reference image is known, to select a reference image that best match the captured image. The imaging device position of the matching reference image can then be considered the imaging device position of the captured image. The reference images may form a composite image of the entire viewable scene. The composite image can be created by stitching together previously captured images of different regions of the viewable scene.

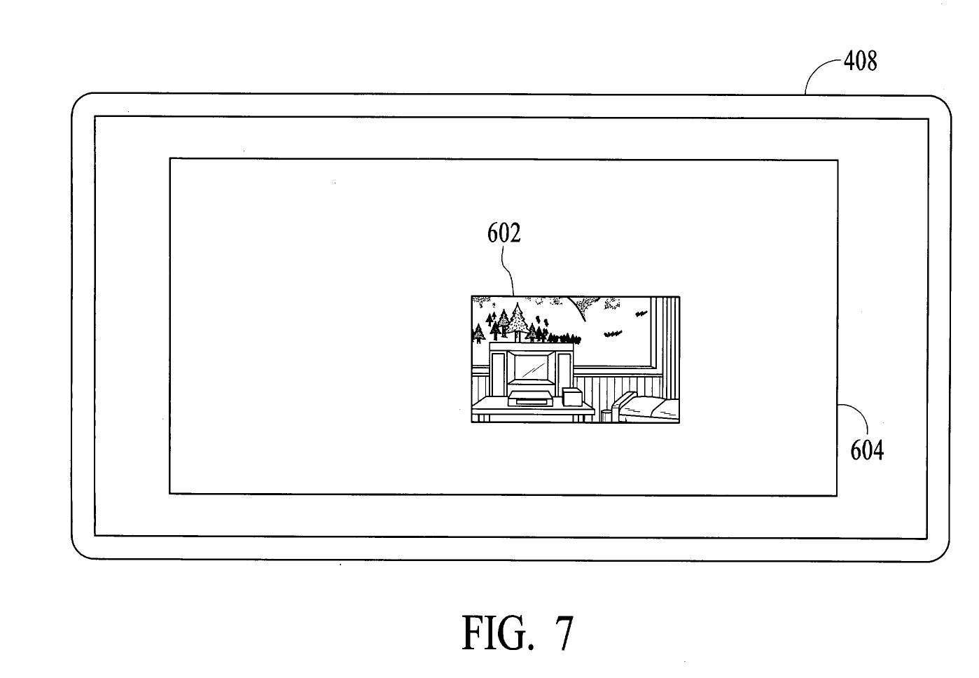

In the exemplary embodiment, the display controller 434 generates the scene frame 604 on the monitor 408 as a graphic user interface (GUI), which may be generated using JavaScript. As a GUI, the scene frame allows a user to not only view the images captured by the imaging device 402 at the current imaging device position, which are selectively positioned on the frame, but to also change the position of the imaging device. In this embodiment, the scene viewed in the frame generated by the display controller is configured to be responsive to a user selection of a particular spot in the scene frame. The selection may be made by moving a cursor to the desired spot in the scene frame using the computer mouse 432 of the input unit 426 or by inputting the coordinate information of the desired spot using the keyboard 430 of the input unit. Alternatively, the selection may be made by moving the image window 602 to the desired spot in the scene frame. In response to the user selection, the display controller transmits control signals to the device positioning mechanism 414 of the imaging assembly 410 to move the imaging device 402 to a new imaging device position so that a different region of the viewable scene is targeted by the imaging device that corresponds to the selected spot in the GUI scene frame. As an example, assuming that the scene frame 604 in FIG. 6 is a GUI, when a user selects a spot 606 on the scene frame using a cursor 608, the display controller moves the imaging device to a new position to target a different region 506 of the viewable scene 504 in FIG. 5, which corresponds to the selected spot on the scene frame. In addition, the image window 602 is moved to a new location in the scene frame to reflect the new imaging device position, which coincides with the selected spot in the scene frame, as illustrated in FIG. 7.

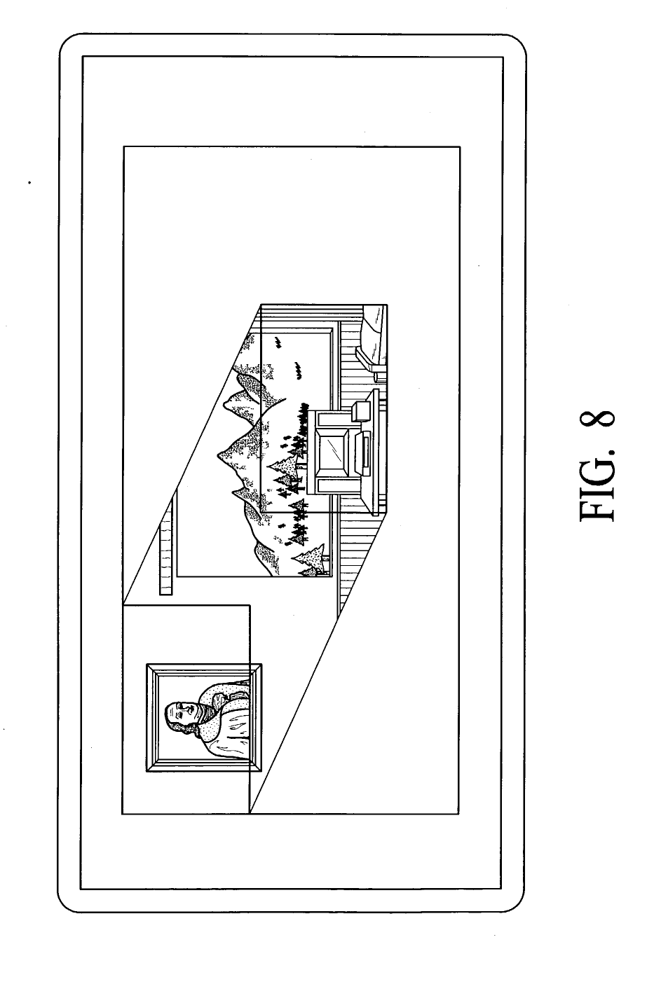

As the imaging device 402 moves to the new position, the imaging device may continue to capture new images, which can be displayed on the scene frame 604, as illustrated in FIG. 8. Thus, these images are displayed at different locations in the scene frame, which correspond to the various imaging device positions, as the imaging device moves to the new position. In one configuration, the images captured at various imaging device positions remain displayed on the scene frame, as shown in FIG. 8. In this configuration, the image window 602 with the current image can be differentiated by a highlighted border. In another configuration, only the current image is displayed in the scene frame. Thus, in this embodiment, the images that were captured at previous imaging device positions are not displayed in the scene frame.

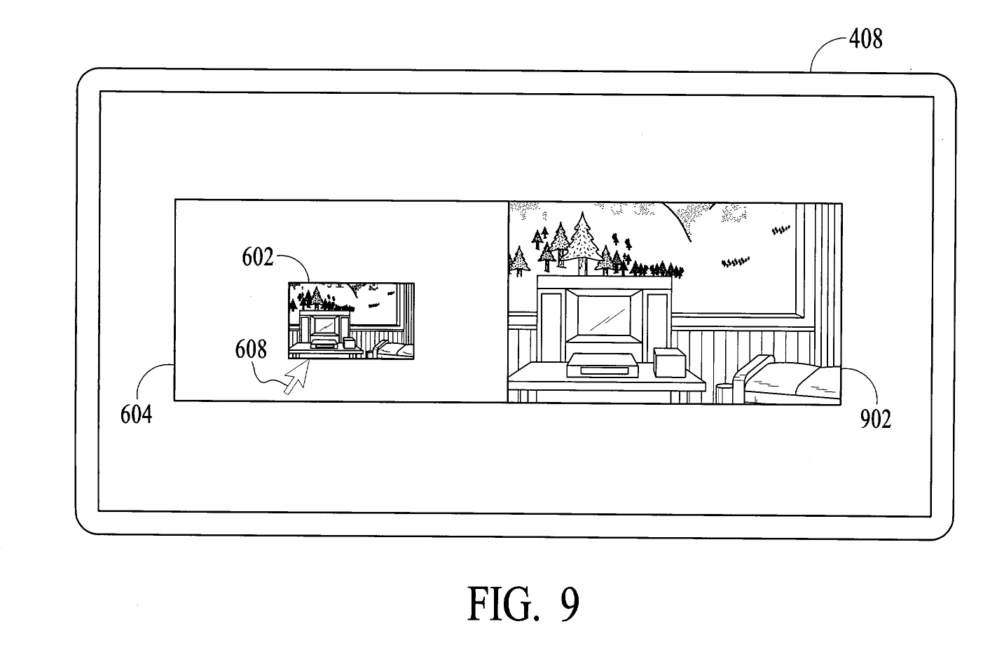

In addition to the GUI scene frame 604, the display controller 434 may generate a viewing frame 902 that also displays the current images, as illustrated in FIG. 9. The viewing frame displays an enlarged version of the current images displayed in the GUI scene frame. In this embodiment, the zooming function of the imaging device 402 may be controlled via the GUI scene frame. As an example, the image window 602 in the GUI scene frame may include a GUI “rubber band” region, which is a controllable border that can be adjusted to increase or decrease the size of the image window. The GUI “rubber band” can be adjusted by means of the computer mouse 432 or the keyboard 430 of the input unit 432. The GUI “rubber band” region can be increased or decreased to control the zooming function of the imaging device. In this example, the zooming is increased when the area defined by the GUI “rubber band” region of the image window is decreased. Conversely, the zooming is decreased when the area defined by the GUI “rubber band” region of the image window is increased. The area defined by the GUI “rubber band” region of the image window may be changed by dragging one or more sides of the GUI “rubber band” region using the cursor 608.

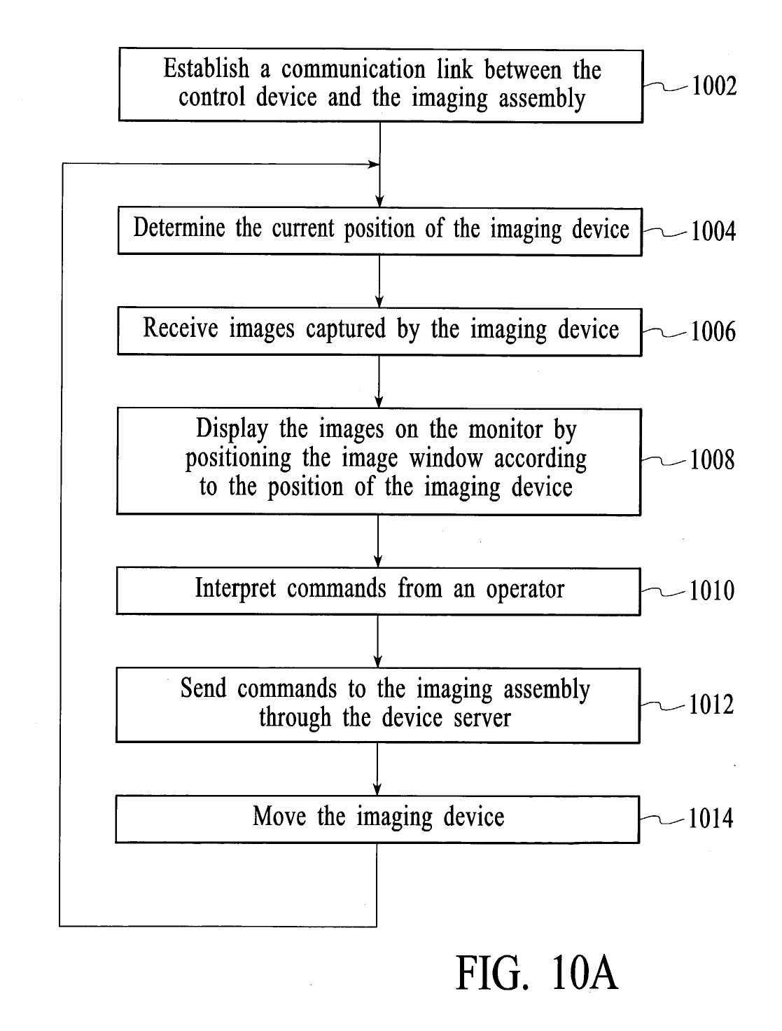

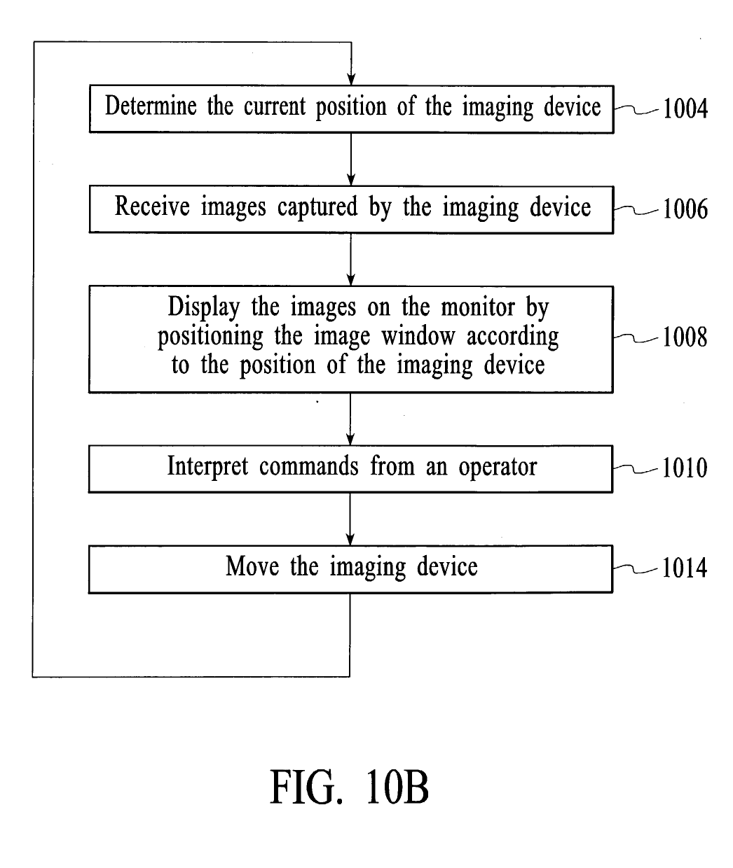

One embodiment of the overall operation of the remote-controllable imaging system 400 is now described with reference to the flow diagram of FIG. 10A. At block 1002, a communication link is established between, for example, the control device 406 and the imaging assembly 410 through the device server 404. Next, at block 1004, the current position of the imaging device 402 of the imaging assembly is determined by reading data from the device sensor 412. Alternatively, the current position of the imaging device is determined by analyzing the captured images or by interpreting a log of control inputs transmitted from the control device to the device positioning mechanism 414 of the imaging assembly. At block 1006, images captured by the imaging device are received at the control device as image data. Next, at block 1008, the images are displayed on the monitor 408 by the display controller 434 by positioning the image window 602 according to the position of the imaging device when the images were captured. The image window is positioned in the scene frame 604 that corresponds to the determined position of the imaging device. In an embodiment, the images are also displayed in the viewing frame 902, which is generated by the display controller.

Next, at block 1010, commands from an operator are interpreted by the processing unit 428 of the control device 406. At block 1012, in response to the operator commands, control signals are sent to the device positioning mechanism 414 of the imaging assembly 410 through the device server 404 from the control device. Next, at block 1014, the imaging device 402 is moved to a new position in response to the control signals received by the device positioning mechanism. In the exemplary embodiment, the user command to move the imaging device to a new position is made by selecting a desired spot in the scene frame 604, which is a GUI in this embodiment. In response to the selected spot in the GUI scene frame, control signals are transmitted to the device positioning mechanism to move the imaging device to the new position, which corresponds to the selected spot in the GUI scene frame. As the imaging device moves to the new position, the images captured by the moving imaging device may be displayed in the scene frame, as illustrated in FIG. 8. Next, the process proceeds back to block 1004 so that the new position of the imaging device can be determined and captured images can be displayed in the image window, which is positioned in the scene frame according to the new imaging device position. In this fashion, images captured by the imaging device are dynamically displayed on the monitor in accordance with the position of the imaging device.

In other embodiments, the overall operation of the remote-controllable imaging system 400 may not include one or more steps described above. As an example, the overall operation of the remote-controllable imaging system may not include steps corresponding to blocks 1002 and 1012, as illustrated in FIG. 10B.

Although the remote-controllable imaging system 400 has been illustrated and described as being configured so that the imaging device 402 can be remotely controlled by the control device 406, alternative embodiments of the remote-controllable imaging system are possible in which the imaging device is not controlled by the control device. In some of these alternative embodiments, the position of the imaging device is controlled by an external mechanism. Consequently, in these alternative embodiments, the main function of the remote-controllable imaging system is limited to dynamically displaying the captured images on the monitor, depending on the position of the imaging device. As an example, in an alternative embodiment, the imaging device and the device positioning sensor 412 may be attached to a helmet of a driver or pilot. In this embodiment, the position of the imaging device corresponds to the orientation of the helmet. Consequently, the location of the images displayed on the monitor of the control device corresponds to the viewing direction of the driver or pilot. Thus, the viewing direction of the driver or pilot can be readily determined by the location of the displayed images on the monitor. In another alternative embodiment, the imaging device and the device positioning sensor may be attached to a mechanism that automatically tilts and/or pans the imaging device in a predefined routine. In this embodiment, the location of the displayed images corresponds to the current position of the imaging device in the predefined routine. Thus, the current position of the imaging device with respect to the predefined routine can be readily determined by the location of the displayed images.

In other alternative embodiments, the imaging device 402 may be stationary, while the scene moves under the control of an operator using the control device 406. Thus, in these alternative embodiments, the position of the imaging device is defined by the movement of the scene being imaged. Thus, as used herein, the position of the imaging device may be the relative position of the imaging device with respect to the scene. As an example, the imaging device 402 may be a stationary video microscope and the scene being imaged may be a specimen on a controllable platform. In this example, the images captured by the video microscope are selectively displayed at different locations of the monitor 408, depending on the relative position of the video microscope with respect to the specimen when the images were captured. A particular relative position of the video microscope is changed by moving the controllable platform on which the specimen is located.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for displaying images comprising:
receiving an input image captured by an imaging device, said input image corresponding to a region of a scene viewable by said imaging device; and
displaying said input image on a portion of a display, including positioning said input image at a location on said display that corresponds to a position of said imaging device with respect to said scene when said input image was captured.

2. The method of claim 1 wherein said displaying further comprises determining said position of said imaging device.

3. The method of claim 2 wherein said determining of said position of said imaging device includes determining at least one angle of said imaging device selected from a group consisting of panning angle, tilting angle and rotational angle.

4. The method of claim 2 wherein said determining of said position of said imaging device includes determining at least one of shifted horizontal position and shifted vertical position of said imaging device.

5. The method of claim 2 wherein said determining of said position of said imaging device includes determining a relative position of said imaging device with respect to said scene.

6. The method of claim 2 wherein said determining of said position of said imaging device includes receiving data regarding said position of said imaging device from a sensor operatively coupled to said imaging device.

7. The method of claim 2 wherein said determining of said position of said imaging device includes interpreting control inputs that were used to move said imaging device to said position.

8. The method of claim 2 wherein said determining of said position of said imaging device includes analyzing said input image with a reference image to determine said position of said imaging device.

9. The method of claim 1 further comprising:
receiving a new image captured by said imaging device at a new position; and
displaying said new image at a new location on said display that corresponds to said new position of said imaging device.

10. The method of claim 9 wherein said displaying of said new image includes displaying said new image at said new location on said display along with said input image.

11. The method of claim 9 further comprising removing said input image from said display.

12. The method of claim 1 further comprising generating a graphic user interface on said display, said graphic user interface being configured to change said position of said imaging device to a different position in response to a user selection of a particular location on said display, said different position of said imaging device corresponding to said particular location on said display.

13. The method of claim 1 further comprising concurrently displaying an enlarged version of said input image on said display with said input image.

14. A system for displaying images comprising:
an interface to receive an input image captured by an imaging device, said input image corresponding to a region of a scene viewable by said imaging device;
a display that can display said input image on a portion of said display; and
a display controller operatively connected to said display to display said input image, said display controller being configured to position said input image at a location on said display that corresponds to a position of said imaging device with respect to said scene when said input image was captured.

15. The system of claim 14 wherein said display controller is configured to determine said position of said imaging device.

16. The system of claim 15 wherein said display controller is configured to determine at least one angle of said imaging device selected from a group consisting of panning angle, tilting angle and rotational angle to determine said position of said imaging device.

17. The system of claim 15 wherein said display controller is configured to determine at least one of shifted horizontal position and shifted vertical position of said imaging device to determine said position of said imaging device.

18. The system of claim 15 wherein said display controller is configured to determine a relative position of said imaging device with respect to said scene.

19. The system of claim 15 further comprising a sensor operatively coupled to said imaging device, said sensor being configured to obtain information regarding said position of said imaging device.

20. The system of claim 19 wherein said sensor includes a potentiometer.

21. The system of claim 15 wherein said display controller is configured to interpret control inputs that were used to move said imaging device to said position to determine said position of said imaging device.

22. The system of claim 15 wherein said display controller is configured analyze said input image with a reference image to determine said position of said imaging device.

23. The system of claim 14 wherein said display controller is configured to display a new image captured by said imaging device at a new location of said display, said new location corresponding to a new position of said imaging device when said new image was captured.

24. The system of claim 23 wherein said display controller is configured to remove said input image from said display.

25. The system of claim 14 wherein said display controller is configured generate a graphic user interface on said display, said graphic user interface being configured to change said position of said imaging device to a different position in response to a user selection of a particular location on said display, said different position of said imaging device corresponding to said particular location on said display.

26. The system of claim 14 wherein said display controller is configured to concurrently display an enlarged version of said input image on said display with said input image.

27. A program storage device readable by a machine, tangibly embodying a program of instructions executable by said machine to perform a method of displaying images, said method comprising:
receiving an input image captured by an imaging device, said input image corresponding to a region of a scene viewable by said imaging device; and
displaying said input image on a portion of a display, including positioning said input image at a location on said display that corresponds to a position of said input imaging device with respect to said scene when said input image was captured.

28. The program storage device of claim 27 wherein said displaying further comprises determining said position of said imaging device.

29. The program storage device of claim 28 wherein said determining of said position of said imaging device includes determining at least one angle of said imaging device selected from a group consisting of panning angle, tilting angle and rotational angle.

30. The program storage device of claim 28 wherein said determining of said position of said imaging device includes determining at least one of shifted horizontal position and shifted vertical position of said imaging device.

31. The program storage device of claim 28 wherein said determining of said position of said imaging device includes determining a relative position of said imaging device with respect to said scene.

32. The program storage device of claim 28 wherein said determining of said position of said imaging device includes interpreting control inputs that were used to move said imaging device to said position.

33. The program storage device of claim 28 wherein said determining of said position of said imaging device includes analyzing said input image with a reference image to determine said position of said imaging device.

34. The program storage device of claim 28 wherein said determining of said position of said imaging device includes receiving data regarding said position of said imaging device from a sensor operatively coupled to said imaging device.

35. The program storage device of claim 28 wherein said method further comprises:
receiving a new image captured by said imaging device at a new position; and
displaying said new image at a new location on said display that corresponds to said new position of said imaging device.

36. The program storage device of claim 35 wherein said method further comprises removing said input image from said display.

37. The program storage device of claim 27 wherein said method further comprises generating a graphic user interface on said display, said graphic user interface being configured to change said position of said imaging device to a different position in response to a user selection of a particular location on said display, said different position of said imaging device corresponding to said particular location on said display.
